(19) United States
(12) Patent Application Publication
(10) Pub. No.: US 2017/0015603 A1
(43) Pub. Date: Jan. 19, 2017

(54) Grove Guard

(71) Applicant: Kenneth W. Hall, Sarasota, FL (US)

(72) Inventor: Kenneth W. Hall, Sarasota, FL (US)

(21) Appl. No.: 14/799,531

(22) Filed: Jul. 14, 2015

(51) Int. Cl. C05G 3/02

(52) U.S. Cl. CPC C05G 3/02

(57) ABSTRACT

A composition of matter having a powderized and or tablet form that can also be dissolved in water solution having the following component compounds adding to a unitary total in ranges of: Sodium Lauryl Sulfate; Citric Acid; Sodium Bicarbonate; Carnauba Wax. The composition has several embodiments indicating various ranges for the compounds therein. Once liquefied the solution can be sprayed unto affected trees in order to provide nutritional benefits that may fight fungi, bacteria and viral pathogens that threaten the well being of plants as well as providing growth enhancing effects; in particular, the psyllid pest is damaged and even killed by the composition. A binding agent is added for its tablet form or alternatively, the carnauba wax is used as a binding agent.

### FIELD OF THE INVENTION

The present invention relates to a composition presented in powder form or as a concentrated agricultural plant spray or liquid mixture. More particularly the invention provides a treatment for plants that has a fungicidal, nutritional, insecticidal and bacteriological treatment in a single application of the composition.

### BACKGROUND OF THE INVENTION

The outside environment subjects plants to various stresses with which they are compelled to overcome. Chief amongst these are a large number of a disease causing catalysts such as viruses, pathogens, bacteria and fungi; additionally, insects can cause considerable damage to the plant in various ways such as the consumption of the leaves, trunk and more as well as assisting in the transmission of the aforementioned disease catalysts into the plant.

Citrus plants as well as other fruit bearing tress are the object of various disease causing catalysts that can also be spread therein by wind, rain and by other means. Various diseases have spread globally and local governments have even decided to destroy the affected trees as soon as the problem is detected. Amongst these are some that are caused by an Asian insect known commonly as a citrus psyllid. This disease as well as their associated disease vectors are particularly problematic for citrus crops as is the insect facilitating the disease.

Thus, these diseases have harmed untold numbers of farmsteads throughout the worlds and no known cure has been developed. Additionally, treatments have been developed that attempt to overcome the effects of the diseases but results have provided mixed results. For example, the response some consists of primarily of the use of copper-based compounds to counteract the disease. These copper sprays have resulted in marginal benefits at best and require multiple re-applications that do not appear to be providing any benefits. Additionally, the mixtures employed do not provide sufficient nutritional benefits that can boost the health of plants and trees affected by one or more diseases.

Thus, there needs be a solution that overcomes these deficiencies and that is easy to use and made from common components that are inexpensive. Additionally, it is desirable to have a general composition that is powdered, water soluble and that can provide plant life with a nutritional supplement to overcome various adverse environmental factors.

### SUMMARY OF THE INVENTION

A composition of a plurality of powdered compounds that provides nutrition enhancing assistance to a treated plant consisting of various ranges of percentages or fractions of a unit by weight as described below in the specification.

In a preferred embodiment the composition includes essentially all of the above described components in a stable substantially soluble form that has an appreciably long shelf life. The composition is first composed in dry powder form by weight on a percentage by weight basis as follows:

A composition that provides nutritional assistance to a plant comprising:
Sodium Lauryl Sulfate with a percentage by weight of 4% and
Citric Acid with a percentage by weight of 40%.

In another aspect, Sodium Bicarbonate with a percentage by weight of 54%.

In another aspect, Carnauba Wax with a percentage by weight of 2%.

In another aspect,
Sodium Bicarbonate with a percentage by weight of 54%.
Carnauba Wax with a percentage by weight of 2%.

A composition of a plurality of powdered compounds that provides nutrition enhancing assistance to a plant comprising:
Sodium Lauryl Sulfate
Citric Acid
Sodium Bicarbonate
Carnauba Wax.

In another aspect, further comprising:
an amount within 5% of the value by weight as described by percentage weights: Sodium Lauryl Sulfate 4%; Citric Acid 40%; Sodium Bicarbonate 54%; Carnauba Wax 2%.

In another aspect, further comprising:
an amount within 10% of the value by weight as described by percentage weights: Sodium Lauryl Sulfate 4%; Citric Acid 40%; Sodium Bicarbonate 54%; Carnauba Wax 2%.

In another aspect, further comprising:
an amount within 20% of the value by weight as described by percentage weights: Sodium Lauryl Sulfate 4%; Citric Acid 40%; Sodium Bicarbonate 54%; Carnauba Wax 2%.

In another aspect, further comprising percentage weights ranges as follows: Sodium Lauryl Sulfate 0.5%-30%; Citric Acid 0.5%-60%; Sodium Bicarbonate 0.5%-60%; Carnauba Wax. 5%-15%.

In another aspect, wherein the Sodium Lauryl Sulfate has a unique range as described by percentage weight: Sodium Lauryl Sulfate 0.5%-30%.

In another aspect, wherein the Citric Acid has a unique range as described by percentage weight: Citric Acid 0.5%-60%.

In another aspect, wherein the Sodium Bicarbonate has a unique range as described by percentage weight: Sodium Bicarbonate 0.5%-60%.

In another aspect, wherein the Carnauba Wax has a unique range as described by percentage weight: Carnauba Wax 0.5%-15%.

A composition of several compounds in powder form that provides nutrition enhancing assistance to a treated plant comprising:
Sodium Lauryl Sulfate with a range percentage by weight of 0.5%-30%
Citric Acid with a range percentage by weight of 0.5%-60%
Sodium Bicarbonate with a range percentage by weight of 0.5%-60%
Carnauba Wax with a range percentage by weight of 0.5%-15%.

In another aspect, wherein the composition is dissolved in a container of water.

Therefore, it should be understood that other embodiments having ranges of the aforementioned components are described for example; sodium lauryl sulfate 0.20 as one ingredient means the other three ingredients would take up the remainder adding to a total unit of 1 by weight. The composition is either in pill form, powder form or wherein the composition is dissolved in a container of water.

These and other aspects, features, and advantages of the present invention will become more readily apparent from the attached drawings and the detailed description of the preferred embodiments, which follow.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in the figures if any. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In the context of this disclosure, a number of terms are utilized that are described as follows. The term ‘about’ means within 20%, 10% and or most preferably within 5% of a given value or range. In this discussion, each compound or substance are based on a percentage by weight and all of these add to a singular unit 1.00 of the composition. When using an ‘about’ means for example, 5% of citric acid that is 0.40 or 40% of a composition would multiply the about percentage by the weight percentage yielding ±0.02 about 0.40; because 5/100*40/100=2/100=0.02. Thus, about means in this instance between 0.38 to 0.42 of citric acid.

If a range is specified for example, Citric Acid 0.005-0.60 then each end of the range is evaluated as above with the previous example. However, for the lower end of the range only a lower extension is computed whilst for the higher end only a higher extension is computed. Thus, 5/1000*5/100=1/4000=0.00025 for a lower end extension; thus recomputing yields 0.005−0.00025=0.00475 as a lower end.

General

The novel composition of this invention is a solution with the ingredients dissolved in water or a composition of the combined ingredients in powder or tablet form composed essentially of several components, in particular, Sodium Lauryl Sulfate, Citric Acid, Sodium Bicarbonate and Carnauba Wax in appropriate proportions for the task. The novel composition originally in powder form can be appropriately water diluted and thereafter applied to the affected trees or plants. In this manner, the application of the mixture substantially reduces, mitigates or even stops the damage caused by some fungal and bacterial diseases, some insects and various nutritional deficits. In particular, various tests were performed on psyllid affected trees using the following First Embodiment; the results conclusively demonstrated that the psyllid was destroyed on the treated plants.

### First Embodiment

In a preferred embodiment the composition includes essentially all of the above described components in a stable substantially soluble form that has an appreciably long shelf life. The composition is first composed in dry powder form on a percentage by weight basis as follows having percentages of ingredients expressed as decimals of a total unit 1.00 of the composition as follows:

| | |
|---|---|
| Sodium Lauryl Sulfate | .04 |
| Citric Acid | .40 |
| Sodium Bicarbonate | .54 |
| Carnauba Wax | .02 |

The composition thus formed in powder form can be combined with water to make a sprayable solution that has the cited dry percentage based components.

Typically, the composition us made into tablet form with a binding agent or kept in powder form then mixed with water; alternatively, the carnauba wax is the binding agent and no additional binding agent is used. Next, it is combined with water in a suitable trough or container diluted as one or more tablets per quantity of water. This solution is a safe, non-toxic combination that will not harm the environment.

In order to use it effectively against the diseases that afflict any trees or plants the following procedure should be utilized. The liquid solution is placed in an appropriate spritzer bottle or in a large container such as are used with electromechanical pumps. Then the entire plant or tree is covered including all foliage, limbs and trunks. Finally, the treatment of the tree or plant at least twice a week at first is recommended tapering off to monthly applications.

### Second Alternative Embodiment

A second alternative embodiment of the composition described previously includes the same components, however, the components of the composition have different percentage ranges based on the predefined term ‘ABOUT’; the composition is first composed in dry powder form by weight on a percentage by weight basis as follows:

| | |
|---|---|
| Sodium Lauryl Sulfate | about a decimal portion of .04 |
| Citric Acid | about a decimal portion of .40 |
| Sodium Bicarbonate | about a decimal portion of .54 |
| Carnauba Wax | about a decimal portion of .02 |

for a total composition adding to 1 unit.

However, in this embodiment, the components have a percentage basis ‘ABOUT’ that refers to the flexibility of the amount of each component in the composition as defined previously above. The composition thus formed in powder form can be combined with water to make a sprayable solution that has the cited dry percentage based components.

Typically, the composition us made into tablet form with a binding agent or kept in powder form then mixed with water; alternatively, the carnauba wax is the binding agent and no additional binding agent is utilized. Next it is combined with water in a suitable trough or container diluted as one or more tablets per quantity of water. This solution is a safe, non-toxic combination that will not harm the environment.

In order to use it effectively against the diseases that afflict any trees or plants the following procedure should be utilized. The liquid solution is placed in an appropriate spritzer bottle or in a large container such as are used with electromechanical pumps. Then the entire plant or tree is covered including all foliage, limbs and trunks. Finally, the treatment of the tree or plant at least twice a week at first is recommended tapering off to monthly applications.

### Third Alternative Embodiment

A third alternative embodiment of the composition described previously includes the same components having different component ranges. However, in this embodiment, the components have a percentage basis and ranges that refers to the flexibility of the amount of each component in the composition. The composition is first composed in dry powder form by weight on a percentage by weight basis as follows:

| | |
|---|---|
| sodium Lauryl Sulfate | .005-.30 |
| Citric Acid | .005-.60 |
| Sodium Bicarbonate | .005-.60 |
| Carnauba Wax | .005-.15 |

The composition thus formed in powder form can be combined with water to make a sprayable solution that has the cited dry percentage based components.

Typically, the composition us made into tablet form with a binding agent or kept in powder form then mixed with water; alternatively, the carnauba wax can act as the binding agent and in this instance no additional binding agent is utilized. Next it is combined with water in a suitable trough or container diluted as one or more tablets per quantity of water. This solution is a safe, non-toxic combination that will not harm the environment.

In order to use it effectively against the diseases that afflict any trees or plants the following procedure should be utilized. The liquid solution is placed in an appropriate spritzer bottle or in a large container such as are used with electromechanical pumps. Then the entire plant or tree is covered including all foliage, limbs and trunks. Finally, the treatment of the tree or plant at least twice a week at first is recommended tapering off to monthly applications.

The three embodiments herein described can be used in any topical application whether foliar or soil based.

Current Production:

Grove Guard™ helps stop citrus greening caused by the Asian citrus psyllid. Grove Guard™ foliar spray and Grove Guard™ root treatment strengthen citrus trees and increase yield and increase pps. These anti-citrus greening insecticide products are non-toxic, cost-efficient and easy-to-use. Grove Guard™ products help stop citrus drop and help improve grove production, not only for oranges but also for grapefruit, limes and all types of citrus.

Dehydrates Asian Psyllid Eggs

Grove Guard™ foliar spray dehydrates Asian psyllid eggs before they can infect your tree. The Asian psyllid larvae produce bacteria that causes excess starch buildup blocking the circulatory flow of water and nutrients. Grove Guard™ has naturally high anti-bacterial properties that effectively neutralize that harmful bacteria when applied in 30 day cycles.

The above-described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention not be limited to the particular embodiments disclosed as the best mode contemplated for carrying out this invention, but that the invention will include all the embodiments falling within the scope of the appended claims.

What is claimed is:

1. A composition that provides nutritional assistance to a plant comprising:
Sodium Lauryl Sulfate with a percentage by weight of 4% and
Citric Acid with a percentage by weight of 40%.

2. The composition of claim 1, further comprising:
Sodium Bicarbonate with a percentage by weight of 54%.

3. The composition of claim 1, further comprising:
Carnauba Wax with a percentage by weight of 2%.

4. The composition of claim 1, further comprising:
Sodium Bicarbonate with a percentage by weight of 54%.
Carnauba Wax with a percentage by weight of 2%.

5. A composition of a plurality of powdered compounds that provides nutrition enhancing assistance to a treated plant comprising:
Sodium Lauryl Sulfate
Citric Acid
Sodium Bicarbonate
Carnauba Wax.

6. The composition of claim 5, further comprising:
an amount within 5% of the value by weight as described by percentage weights: Sodium Lauryl Sulfate 4%; Citric Acid 40%; Sodium Bicarbonate 54%; Carnauba Wax 2%.

7. The composition of claim 5, further comprising:
an amount within 10% of the value by weight as described by percentage weights: Sodium Lauryl Sulfate 4%; Citric Acid 40%; Sodium Bicarbonate 54%; Carnauba Wax 2%.

8. The composition of claim 5, further comprising:
an amount within 20% of the value by weight as described by percentage weights: Sodium Lauryl Sulfate 4%; Citric Acid 40%; Sodium Bicarbonate 54%; Carnauba Wax 2%.

9. The composition of claim 5, further comprising percentage weights ranges as follows:
Sodium Lauryl Sulfate 0.5%-30%; Citric Acid 0.5%-60%; Sodium Bicarbonate 0.5%-60%; Carnauba Wax 0.5%-15%.

10. The composition of claim 5, wherein the Sodium Lauryl Sulfate has a unique range as described by percentage weight: Sodium Lauryl Sulfate 0.5%-30%.

11. The composition of claim 5, wherein the Citric Acid has a unique range as described by percentage weight: Citric Acid 0.5%-60%.

12. The composition of claim 5, wherein the Sodium Bicarbonate has a unique range as described by percentage weight: Sodium Bicarbonate 0.5%-60%.

13. The composition of claim 5, wherein the Carnauba Wax has a unique range as described by percentage weight: Carnauba Wax 0.5%-15%.

14. A composition of several compounds in powder form that provides nutrition enhancing assistance to a treated plant comprising:
Sodium Lauryl Sulfate with a range percentage by weight of 0.5%-30%
Citric Acid with a range percentage by weight of 0.5%-60%
Sodium Bicarbonate with a range percentage by weight of 0.5%-60%
Carnauba Wax with a range percentage by weight of 0.5%-15%.

15. The composition of claim 14, wherein the composition is dissolved in a container of water.
